(19) United States
(12) Patent Application Publication
(10) Pub. No.: US 2004/0094055 A1
(43) Pub. Date: May 20, 2004

(54) Gravure sleeve

(76) Inventors: Moshe Ben Shlomo, Vancouver (CA); Brian Muir, Vancouver (CA)

Correspondence Address: Owen Cramer, c/o Creo Inc., 3700 Gilmore Way, Burnaby, BC, V5G 4M1, CA

(21) Appl. No.: 10/701,478

(22) Filed: Nov. 6, 2003

Related U.S. Application Data
(60) Provisional application No. 60/426,870, filed on Nov. 18, 2002.

(51) Int. Cl. B41N 1/00

(52) U.S. Cl. 101/395

(57) ABSTRACT

A ready-to-image gravure sleeve is supplied with a resist layer applied over the copper. The sleeve is loaded on a mandrel in an imaging device and imaged directly using an imagewise controllable radiation source. In subsequent processing steps the resist is developed and subjected to a chemical etch to form the gravure image in the copper.

### RELATED APPLICATIONS

This application claims benefit of the filing date of U.S. application Ser. No. 60/426870 provisionally filed on Nov. 18, 2002.

### TECHNICAL FIELD

The invention relates to the field of preparing intaglio or gravure printing forms and more particularly to preparing a gravure sleeve for use in a printing operation.

### BACKGROUND

Gravure printing cylinders commonly have a layer of copper deposited on the external surface of a steel cylinder. The surface of the copper cylinder is engraved to form a plurality of cells representing the image to be printed. Commonly a layer of hard material like chrome is deposited over the copper to improve the durability of the printing surface. On the press, the cylinder is rotated through a fountain of ink and then the excess ink is wiped away from those areas of the cylinder surface that have no gravure-impressions. The ink in the cells is then transferred to the printing medium. The term “Intaglio” printing is used to describe any printing method where the image area is recessed into the plate, gravure printing being just one such intaglio printing method.

Gravure cylinders are engraved using various techniques including electromechanical engraving with a stylus, chemical etching, high power laser engraving and more recently, electron-beam engraving. Regardless of the method used, the preparation of a gravure cylinder is time consuming and requires heavy cylinders to be transported between engraving equipment and the press, often at different locations.

In U.S. Pat. No. 4,556,610 to van Heuvelen, a flexible gravure sleeve having a cylindrical outer surface and a slightly conical inner surface is described. The sleeve fits over a corresponding slightly conical cylindrical core to provide a rigid printing cylinder. The sleeve carries the gravure pattern and may be transported separately from the core cylinder.

In U.S. Pat. No. 6,048,446 to Michaelis, a resist is deposited onto a surface of a gravure cylinder. The resist is capable of being physically and/or chemically changed when exposed to actinic energy. The exposed areas allow a material, such as chromium to be plated onto the surface of the gravure cylinder to form walls that define gravure cells therebetween.

It is well known to prepare a gravure cylinder by coating a resist over the copper surface and then to expose the resist to light through a film mask making the coated surface selectively etchable. The etch solution selectively attacks the cylinder surface where permitted by the resist layer to form the gravure cells.

Etch resists are also well known in the printed circuit board industry (PCB) where a thin layer of a resist composition is coated over a copper on a PCB. The resist is then typically exposed to actinic light through a film mask, which effects a change in the resist composition in the places where the actinic light reaches, while masked areas are unaffected. Depending on the particular resist formulation, either the exposed areas or the un-exposed areas may be etched away in a subsequent processing operation. The image mask is chosen to be either a negative or a positive image of the desired pattern on the PCB to suit the resist in use.

In U.S. Pat. No. 6,255,033 to Levanon et. al., a resist for use in the PCB industry is described. The resist is exposed directly by an imagewise controllable high power laser to form an etch mask.

There remains a need for better methods for handling and preparing gravure printing formes.

### SUMMARY OF THE INVENTION

In a first aspect of the invention a gravure printing sleeve comprises a tubular substrate having an inner and an outer surface, the inner surface sized to fit on a cylinder mandrel. The substrate has a printing surface on the outer surface of the tubular substrate and a resist layer on the printing surface.

In another aspect of the invention a method for preparing a gravure printing element is provided. The method comprises providing a ready-to-image gravure sleeve comprising a tubular substrate having an inner and an outer surface with a printing surface on the outer surface thereof and a resist layer on the printing surface. The ready-to-image sleeve is then loaded into an imaging device and image data representing a gravure image is received. The resist layer is exposed in accordance with the image data and a plurality of gravure cells are etched the printing surface using the exposed resist layer as an etch mask.

### BRIEF DESCRIPTION OF THE DRAWINGS

In drawings which illustrate by way of example only preferred embodiments of the invention;

FIG. 1-A is a perspective view of a sleeve being loaded onto a mandrel;

FIG. 1-B is a sectional view of a sleeve; and

FIG. 2 is a process flowchart depicting a method in accordance with the present invention.

### DESCRIPTION

This invention is described in relation to a sleeve for gravure printing that is prepared by imagewise exposing a resist layer coated over the sleeve surface. This may be followed by a chemical etch to form the gravure cells. The sleeve may be supplied to a printing plant ready to image with the resist layer already applied.

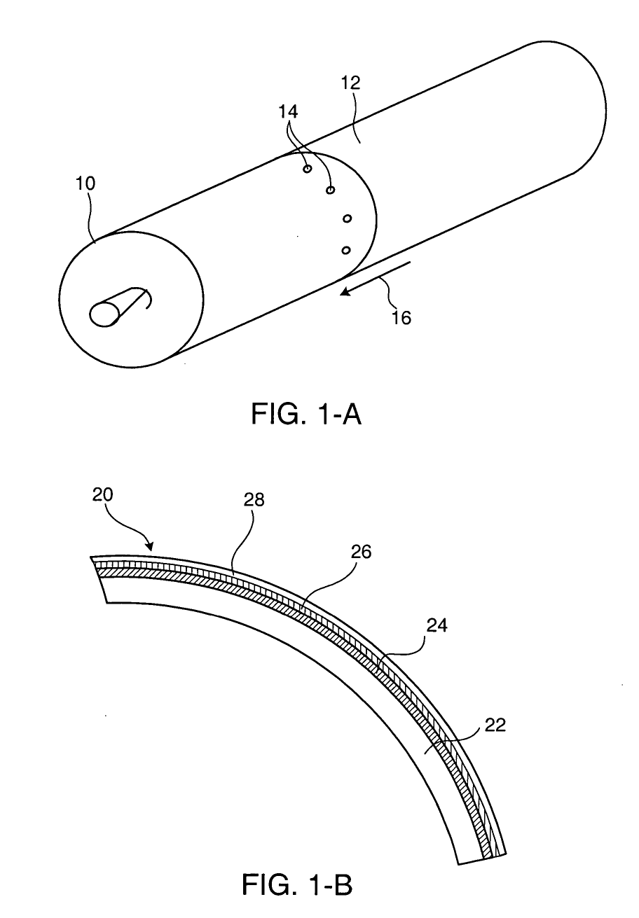

In FIG. 1-A a sleeve 12 is shown in partial engagement with a mandrel 10. The mandrel has a series of holes 14 in its outer surface fed by a source of pressurized air (not shown). The sleeve 12 is capable of at least some elastic expansion and has an inner diameter that is slightly smaller than the outer diameter of mandrel 10. The pressurized air supplied via holes 14 expands the sleeve 12 so that it can be slid onto the mandrel 10 in a direction shown by arrow 16. Once the pressurized air supply is interrupted sleeve 12 contracts to tightly engage mandrel 10 by an interference fit. Alternatively, the sleeve and mandrel may have a corresponding conical taper as described in U.S. Pat. No. 4,556,610 to van Heuvelen or may be a two part mandrel comprising an arbour and an intermediate sleeve as described in commonly assigned U.S. patent application Ser. No. 09/930985.

A section of the sleeve according to an embodiment of the present invention is shown in FIG. 1-B. The sleeve 20 has a generally tubular substrate 22, which is commonly steel but may be any other metal such as nickel, plastic, or a composite material. The substrate 22 forms a base for applying the further layers and is distinguished from gravure cylinders that are known in the art in that the substrate wall is thin and it must be fully supported over the entire inner surface of the sleeve by a mandrel for imaging and/or printing operations. A copper layer 24 is applied over the substrate 22. Layer 24 has a layer of a hard material 26, such as chrome, applied over the copper to reduce the wear rate of the gravure cylinder on press. A resist layer 28 is coated over the chrome layer 26. It is also known in Gravure printing to use Zinc or other materials instead of copper for layer 24. Layers 24 and 26 together form the printing surface which may be “engraved” with a plurality of cells to form a gravure image.

In an alternative embodiment of the present invention, a release layer or so-called “Ballard Layer” may be interspersed between the substrate 22 and the copper layer 24. This layer allows a used gravure printing cylinder to have the used copper stripped off after printing so that the shell can be re-used.

In one embodiment the resist is be a thermal resist of the type described in U.S. Pat. No. 6,255,033 to Levanon et. al. A resist of this type may be exposed directly by an imagewise controllable exposure head of the type commonly used for exposing many types of media including lithographic and flexographic plates and sleeves. Such exposure heads may have a laser source emitting in the infrared, preferably in the wavelength region of about 700 to 1300 nm.

The resist in the Levanon Patent undergoes a thermally-induced change in solubility in the areas exposed to infrared radiation. These areas may be effectively removed in mild alkaline developers leaving the etch-resistant material defining a mask for the non-image areas. Etching in a chemical solution will remove the chrome and copper in the non-masked areas thus forming the desired pattern of gravure cells. The remaining resist may be cleaned off or left to wear off on the printing press.

Advantageously, the sleeves of the present invention may be supplied as stock items with copper, chrome and resist layers applied, much in the same way as blank printing plates are supplied to a lithographic printer. Conveniently, the sleeve may be transported form storage to the imaging device and then on to the processing equipment and finally to the press without a mandrel in place. The imaging device, processing equipment and press may each have an appropriately sized mandrel to locate the sleeve. Alternatively, the sleeve may be taken from storage and placed on a universal mandrel, which follows the sleeve through the various steps in preparing the gravure cylinder for press. On completion of the press run the sleeve may be removed from the mandrel and discarded, stored for further use or stripped of copper and recycled. The mandrel is then available for re-use with another sleeve. Clearly, this affords the opportunity to significantly reduce the weight and monetary investment in gravure cylinder materials (mostly metal such as steel or aluminium) while at the same time improving process flexibility.

Gravure printing has typically been operated on a different basis from other methods of printing such as lithographic printing. In lithographic printing plates may be kept in inventory, imaged, processed and printed all on the same plant floor. In gravure printing, cylinders are often specially prepared in an engraving plant and then transported to a printing plant. Lead times preparing cylinders become significantly longer than for lithographic printing and cylinder re-make represents a significant delay. The methods of present invention allow gravure printing to take place on a similar basis to that used in many other types of printing where plates are prepared on-demand.

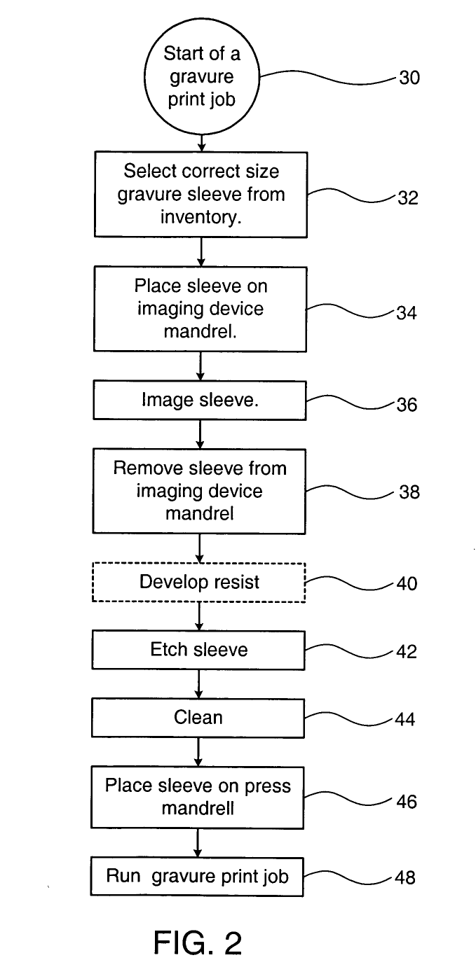

A method according to a specific embodiment of the present invention is shown in the form of a process flowchart in FIG. 2. A gravure print job starts in step 30. The job may require the preparation of one or more gravure sleeves (a colour image may require at least 4 sleeves for Cyan, Magenta, Yellow and Black). The sleeves are selected from an inventory of ready-to-image sleeves in step 32. Advantageously the sleeves in inventory have been prepared as previously described and may have already been coated with the resist formulation. The sleeve is secured on a mandrel and loaded into the imaging device in step 34. In step 36, the sleeve is directly imaged in accordance with image data supplied to the imaging device as is known in the art. The imagewise exposure of the resist effects a change in the properties of the formulation. The resist may or may not require further development or processing to remove imaged or non-imaged portions. This optional processing step is shown as step 40. Such processing may take the form of submerging the surface of the sleeve in an alkaline solution to dissolve resist made soluble by the exposure in step 36. Once the resist has been developed the gravure image cells are etched into the copper/chrome layer using a chemical etchant in step 42. The developing and etching process steps may be performed on equipment adapted to accommodate gravure cylinders. Process steps 36, 40 and 42 may be performed in any combination of devices adapted to accommodate sleeves or may be performed in a multi-purpose device that performs two or more of the steps in sequence.

The etched cylinder, now bearing a gravure image, may require a further cleaning step 44 prior to being mounted on the press mandrel in step 46 and run on press in step 48.

Advantageously, the use of a comparatively lightweight sleeve in the preparation of a gravure printing form simplifies the handling and storage of the gravure printing surface. The sleeve allows some of the efficiencies previously only associated with lithographic and flexographic printing to be realized in the gravure printing process.

As will be apparent to those skilled in the art in light of the foregoing disclosure, many alterations and modifications are possible in the practice of this invention without departing from the spirit or scope thereof.

What is claimed is:

1. A gravure printing sleeve, comprising:
a tubular substrate having an inner and an outer surface, the inner surface sized to fit on a cylinder mandrel;
a printing surface on the outer surface of the tubular substrate; and
a resist layer on the printing surface.

2. A gravure printing sleeve according to claim 1, wherein the tubular substrate is a metallic cylinder.

3. A gravure printing sleeve according to claim 1, wherein the printing surface comprises a layer of copper.

4. A gravure printing sleeve according to claim 3, comprising a layer of chrome on top of the layer of copper.

5. A gravure printing sleeve according to claim 3, comprising a release layer disposed between the substrate and the layer of copper.

6. A gravure printing sleeve according to claim 1, wherein the cylinder mandrel comprises an arbor with an intermediate sleeve slideably located on the arbor.

7. A gravure printing sleeve according to claim 1, wherein the resist layer is adapted to change solubility in response to imagewise exposure by infrared radiation.

8. A method for preparing a gravure printing element, the method comprising:
providing a ready-to-image gravure sleeve comprising a tubular substrate having an inner and an outer surface with a printing surface on the outer surface thereof and a resist layer on the printing surface;
loading the ready-to-image sleeve in an imaging device;
receiving image data representing a gravure image;
exposing the resist layer in accordance with the image data; and
etching a plurality of gravure cells in the printing surface using the exposed resist layer as an etch mask.

9. A method according to claim 8, further comprising removing the etch mask after etching.

10. A method according to claim 8, wherein loading the ready-to-image sleeve in an imaging device comprises:
providing a cylinder mandrel, the mandrel sized for an interference fit with the inner surface of the sleeve;
positioning the sleeve in partial engagement with the mandrel;
introducing a pressurized airflow between the sleeve and the mandrel to expand the sleeve;
sliding the sleeve into full engagement with the mandrel;
interrupting the pressurized airflow, thus allowing the sleeve to contract into an interference fit with the mandrel.

11. A method according to claim 8, further comprising developing the exposed resist layer to form the etch mask.
